(19) United States
(12) Patent Application Publication
(10) Pub. No.: US 2008/0022735 A1
(43) Pub. Date: Jan. 31, 2008

(54) Bicycle readylock

(76) Inventor: Thomas Alan Hood, Willcox, AZ (US)

Correspondence Address: Thomas Alan Hood, P.O. Box 773, Willcox, AZ, 85644, US

(21) Appl. No.: 11/701,157

(22) Filed: Jan. 31, 2007

Related U.S. Application Data
(60) Provisional application No. 60/833,901, filed on Jul. 25, 2006.

(51) Int. Cl. E05B 71/00

(52) U.S. Cl. 70/233

(57) ABSTRACT

What is new about the BICYCLE READYLOCK is that it eliminates all of the problems associated with the other types of lock systems that are available. There is no need to “man-handle” the permanently coiled cables; unwrap chains, which can chip the paint of the bike; or even the various sized U-locks are difficult to remove from their carrying brackets, and then unlock and use them, only to have to do the process all over again when they are ready to ride again. The BICYCLE READYLOCK is the easiest system possible for securely locking your bike without hassle, making your riding experience a carefree, worriless fun adventure with no lagging doubts about whether you should take the time to lock your bicycle or not. The BICYCLE READYLOCK makes the decision and the procedure extremely trouble free, so you have one less headache to worry about.

### BACKGROUND

The idea of my invention came about as a result of my years of riding bicycles. I have always been limited to a choice of two main types of bicycle locks, both of them cumbersom and not very easy to use, especially if I just wanted to run into the Post Office to check the mail, or into a store to pick up something. My mind was always on my bike outside and how quickly someone could just jump on it and take it away.

To lock the bike or not to lock the bike was always a tough decision, especially if I was only going to be away from it for a quick minute or two. But, that's all the time a thief needs to get on your bike and get away with it.

The two main types of locks are the biggest problem. One, a chain, or a cable are hard to uncoil and thread through the spokes, then around a stationary object and get the ends back together to lock them. Afterwards, one has to undo the chain or cable, unthreading it back through the way it went around, coiling them back up and wrapping them around the seat post or some part of the frame. That's a big hassle for just a minute to check your P.O. Box. Plus, of course, the chain and cable are targets for someone serious who has bolt cutters.

The other type of lock is the super tough “Kryptonite” and their lookalikes. The trouble with this lock is finding something that fits inside its narrow shape, and also encloses the frame and the easily removeable front wheel. Also, when not being used the lock must fit in a frame mounted bracket, and the lock, while being super strong is super heavy. It is also large and takes up a lot of interior frame space which could be devoted to waterbottles, tool kits and other miscellaneous useful things.

### BRIEF SUMMARY OF THE INVENTION

For those times when you want to leave your bicycle outside while you run into a store to do a little shopping around, without worrying about your bicycle, I have invented a lock system I call the BICYCLE READYLOCK. It is permanently mounted, as strong as the Krypton type locks, and is never in your way. It takes only seconds to secure your bike, and go somewhere without worrying about it. To get away with your bike, someone would have to pick up the bicycle, lock and all, and walk away with it. Someone who wants your bike that badly is going to take it no matter HOW you have your bike secured. The BICYCLE READYLOCK discourages a thief from just getting on and stealing your bike just because you didn't want to take the time to uncoil the cable lock, or find some good place to use the Kryptonite lock.

The BICYCLE READYLOCK eliminates all of the problems associated with using chain, cable or Krypton type locks. In a second, you can have the lock bar unlocked, swing the READYLOCK down over the front wheel, and re-lock the lock bar. Your front wheel is now securely locked to your bicycle frame and cannot be ridden.

### BRIEF DESCRIPTION OF SEVERAL DRAWINGS

FIG. 1: A stripped down bicycle, (profile view) showing the READYLOCK mounted to the top side of the angle down-tube.
1a: BICYCLE READYLOCK.
1b: READYLOCK pivot bracket. This bracket can be bolted to the frame or welded on during manufacture.

FIG. 1A: Same view as FIG. 1, with the READYLOCK in the down and locked position.
1c: Rubber bumper pad for locking crossbar to rest on.
1d: Velcro strap for securing the READYLOCK to the rubber bumper.

FIG. 2: READYLOCK parts shown in detail, open view.
1a: READYLOCK arms. Instead of threading, READYLOCK halves could be made of one solid piece of chrome molly steel, and the pivot bracket welded in place. (See FIG. 5).
1b: READYLOCK PIVOT. (Shown here with bolt holes to make any bicycle accept a READYLOCK retrofit).
1c: Rubber bumper pad.
1d: Velcro hold down strap.
1e: Frame downtube on which READYLOCK is either bolted or welded.
1g: Locking crossbar. (Contains a keyed lock).

FIG. 3: Close view from the top (Top crossbar removed).
BICYCLE READYLOCK is shown with pivot bracket bolted to frame and velcro strap holding down the locking crossbar.

FIG. 4: Alternate mounting position if shifting or brake cables run along the top of the angle frame downtube. The entire BICYCLE READYLOCK can be mounted on either side of the angle frame downtube.

FIG. 4 also shows the locking crossbar coming off of the READYLOCK arms, the READYLOCK moved to the down position, and the locking crossbar ready to lock in place.

FIG. 5: Alternate method of attaching READYLOCK to READYLOCK pivot bracket. READYLOCK is placed in lower half of bracket, and then the top-cap is welded on.
5a: Pivot top cap.
5b: Pivot bottom half.
5c: Finished weld on READYLOCK pivot bracket.

### DETAILED DESCRIPTION OF THE INVENTION

My BICYCLE READYLOCK is different, and better, than any bicycle lock available. One: It is permanently mounted to the frame. This means that the bicycle can be locked wherever it happens to be, you don't have to go hunting for suitable stationary objects to lock to. Two: The lock takes up very little space and is light in weight. You don't have to find a suitable place to wrap a cable around the frame or seatpost. Three: The BICYCLE READYLOCK takes only seconds to secure your bike, and is easy. This lock system is simple! The BICYCLE READYLOCK makes it easy to decide to lock your bike anytime, wherever you are.

As to the manufacture of the READYLOCK, there are two ways one could undertake to make and assemble the lock: (FIGS. 2&5);

As shown in FIG. 2, the two lengths of steel used for the arms of the lock can be bent at one end to form a 90° bend. One of the bends can be drilled out and tapped. The other bend can be threaded to fit the threaded “sleeve”. The pivot bracket can be a solid casting or machined out of a block of steel or aluminum. The two arms are then screwed together within the solid pivot bracket. The pivot bracket, complete with parallel steel arms, is then bolted to the frame of the bike through two holes that have been drilled and tapped in the frame tube. The locking crossbar is machined to be fitted with a lock that will lock both arms of the READYLOCK, and the crossbar lock is fitted to the two READYLOCK arms. A small rubber bumper is epoxyed to the frame tube where the locking bar crosses the frame tube. Also the velcro strap is measured for length and cut to size. The velcro strap can also be epoxyed to the frame tube where it will cross over the rubber bumper, with enough length to cross over the locking bar and re-attach to the velcro pad on the other side of the bar. (FIGS. 2, 1d)
As shown in FIGS. 5 and 5A, the READYLOCK pivot bracket can be machined or stamped out of steel or aluminum in two halves: an upper and a lower half.
First, a length of hardened alloy steel is measured to length, two 90 degree bends are put into the steel rod so that there is a small straight section at the apex that will fit into the bottom half of the pivot bracket (FIG. 5b). The top half of the bracket is then placed in position on the lower half of the bracket, enclosing the steel rod within the pivot bracket. Now the top cap can be welded in place and the READYLOCK pivot bracket is ready to mount onto the bicycle frame in the same manner as in the first example. The rubber bumper (FIGS. 2, 1c) and the velcro strap (FIGS. 2, 1d) are also attached in the same manner as in the previous example (FIG. 3).

The best mode I can contemplate of manufacture of this invention is the second example above. I believe machinery can accomplish many of the steps in the manufacturing process. For example, I believe automated welders could accomplish welding the top cap onto the bottom half of the READYLOCK. Also, machines would perform the exacting job of bending the steel rod into two uniform 90 bends with the required inch to an inch and a half of straight section between the two arms of the READYLOCK. Also, machinists would bore out the locking crossbar for the two steel arms to enter the crossbar, as well as bore through the end to allow the locking mechanism to fit and engage the READYLOCK locking mechanisms at the ends of the READYLOCK arms. Bolting the pivot bracket to the top of the frame downtube is my recommended attachment, with one exception.

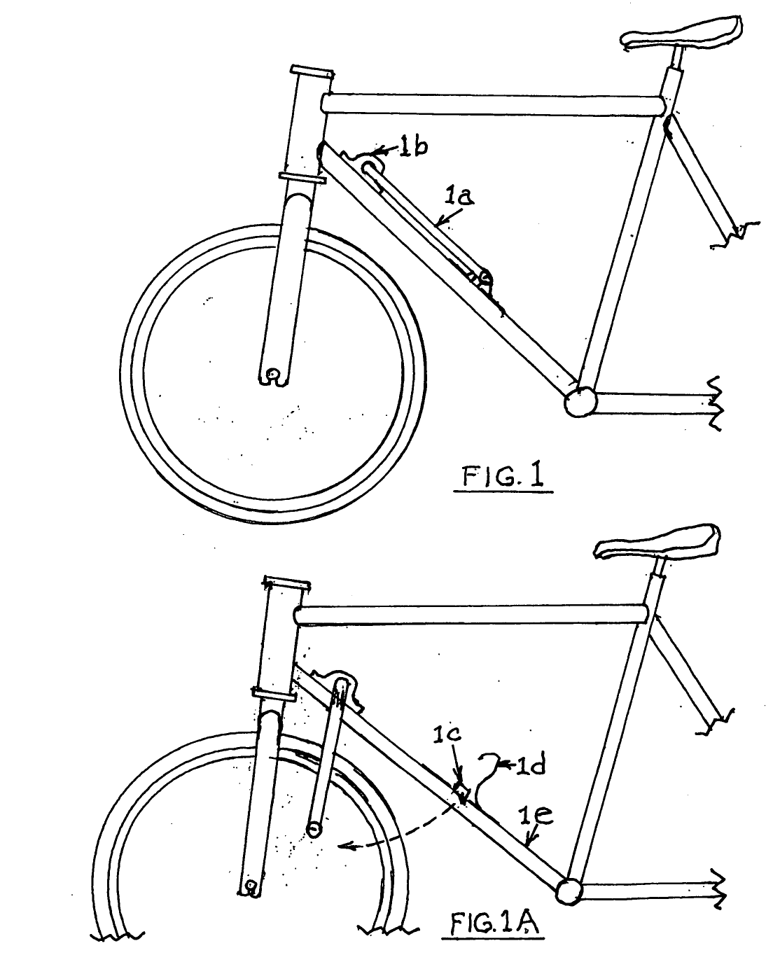

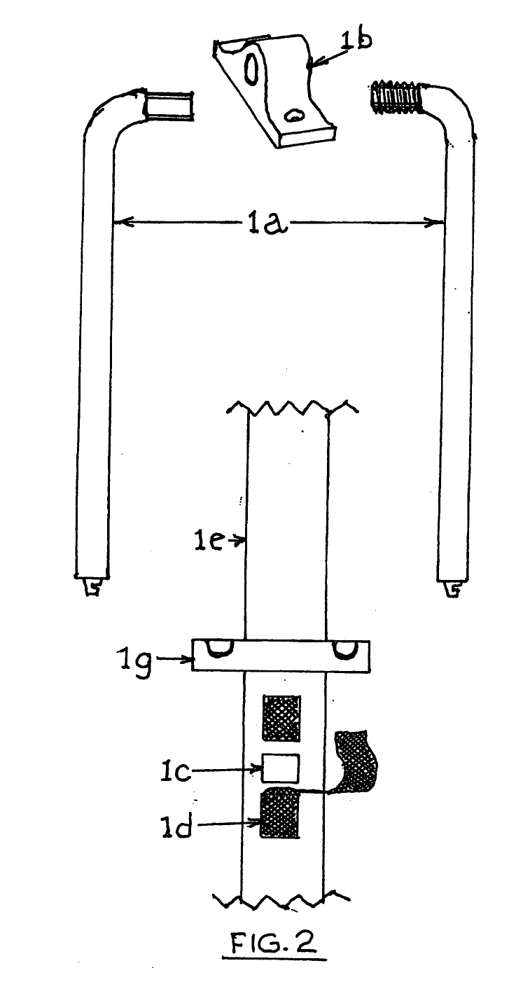

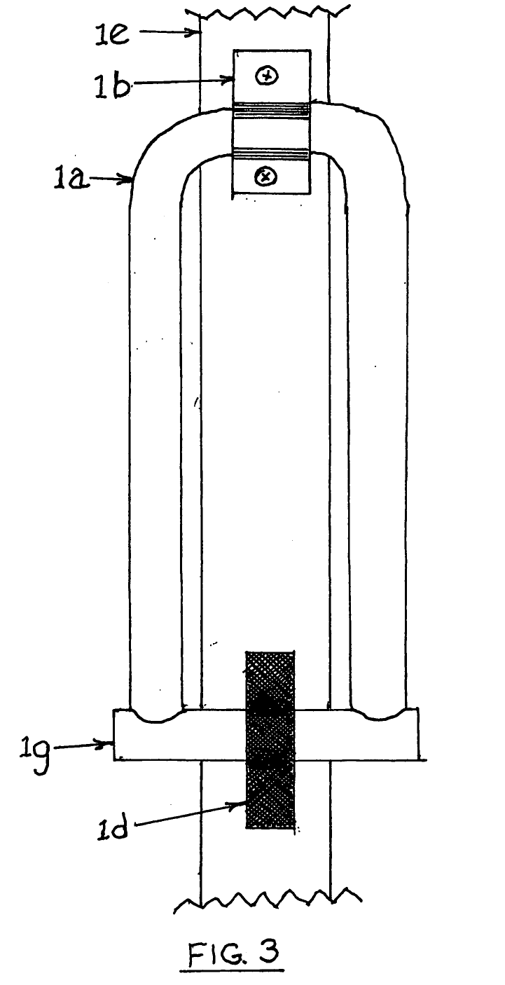

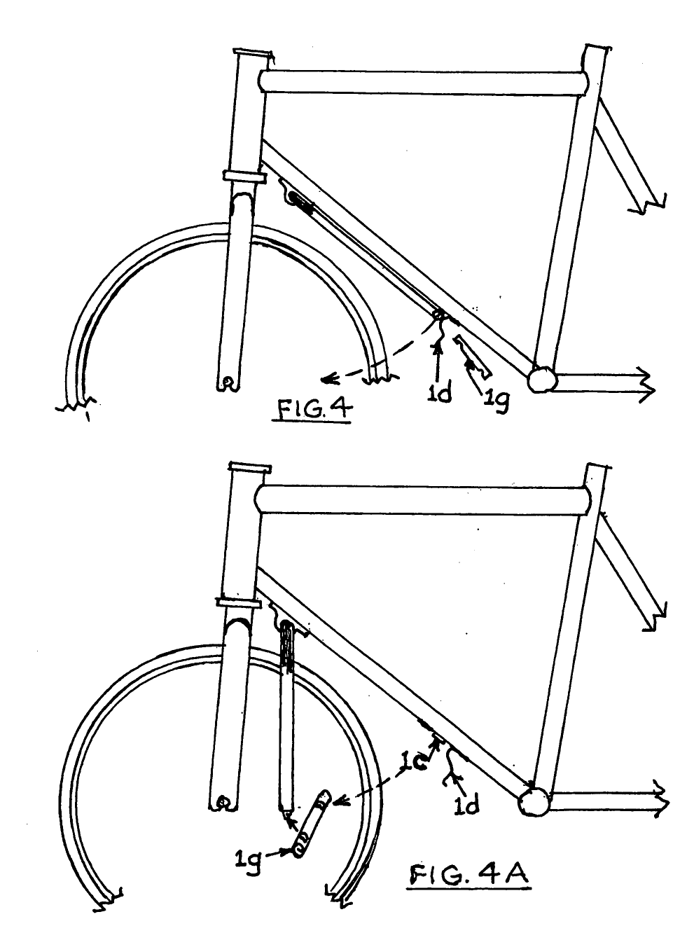

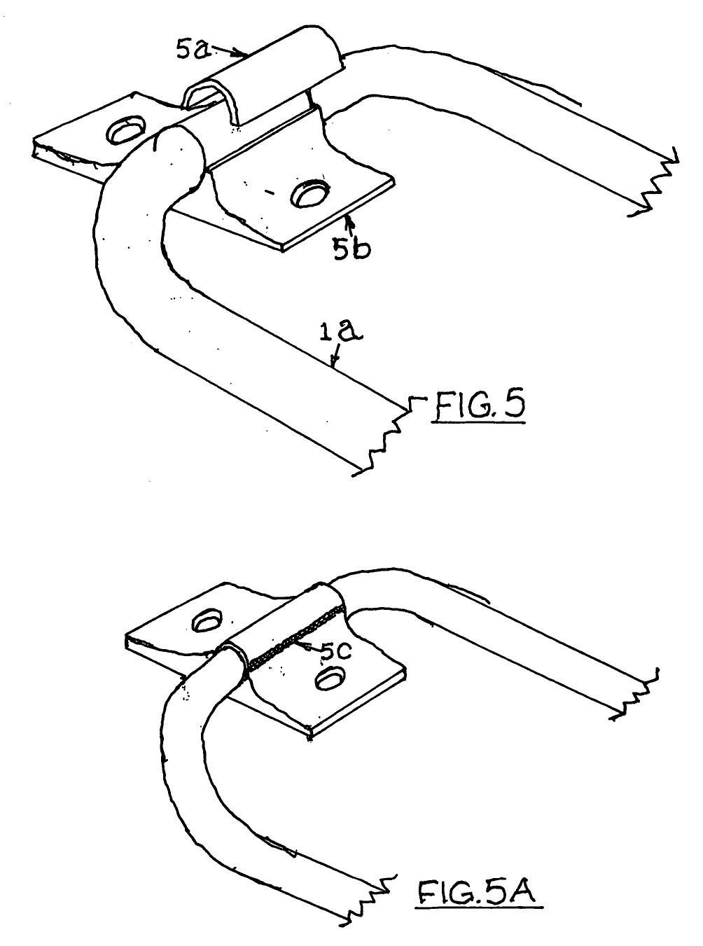

If the BICYCLE READYLOCK must be mounted on the bottom of the frame tube (FIGS. 4, 4A), I would weld the bracket in place instead of bolting. The reason being that with the pivot bracket on the outside of the interior frame area, it could be unbolted and removed from the bicycle and the bicycle then being stolen.

I know that my READYLOCK is similar in shape to the bigger Kryptonite type locks, so I know the technology already exists to make my locking crossbar-fit the READYLOCK arms. What is new and different is the permanent mounting of the lock to the frame. The smaller size required to fit the frame makes the lock smaller and therefore lighter. However, made with a high grade alloy steel, the theft by breaking the lock method would still require a thief to destroy the bicycle before they could get the lock off of it. Also, I believe that my BICYCLE READYLOCK will be as easy to use as unlocking your car door and closing it back. That kind of simplicity is what is going to make the BICYCLE READYLOCK VERY USEFUL, VERY POPULAR, AND A VERY DESIRABLE ACCESSORY TO ANY BICYCLE RIDER.

With the price of gas rising ever higher, more and more people are going to go back to riding bicycles, to go to work and to ride for pleasure. An easy, carefree lock that is always with the bicycle and requires no effort to make the bike safe when left alone for a few minutes, is going to be in great demand. Bicycle shops are going to benefit from the great demand to get the BICYCLE READYLOCK mounted to older bikes. Bicycle manufacturers are going to benefit from selling new bikes with the BICYCLE READYLOCK already installed at the factory. A look at FIG. 1 shows how compact the READYLOCK can be. A look at FIG. 1A shows how simple the lock is to operate. I believe that simplicity and having bicycles safely locked is a combination that is going to sell.

The photos, 1 through 8, are a representation of the Readylock mounted on a bicycle. It is a mock-up that I fabricated from ½ inch PVC plastic pipe. An actual Bicycle Readylock would be smaller, more rounded than the example I made, which had to be rectangular in shape because of the materials I had available to me to make a working model.

Bicycle locks of all shapes and types have long been in the field of art of bicycle locks. My invention is based mainly on the manufacture and use of the permanent mounting swivel bracket, which is unique in the field of bicycle locks, in that it permanently holds the U-shaped lock in a position that is ready for immediate use of the lock. It is out of the way, weighs less than others, but is made of a high carbon alloy steel that will not be cut by bolt cutters, or sawed through. The user simply unlocks the crossbar, swings the lock over the front wheel and re-locks the crossbar to the lock arms. When ready to ride again the rider merely unlocks the crossbar, swings the lock arms back up and over the bicycle frame bar, and re-locks the crossbar to it.

In an earlier section of the Specification, I described two different methods of manufacture of the permanently mounted Swivel bracket and U-shaped lock. I am sure there is an engineer out there who can design a better form of permanently mounted swivel brackets which will permanently mount the lock to the frame. However that still falls under the scope of my invention, the always ready frame mounted swivel bracket and associated U-shaped lock.

### BRIEF DESCRIPTION OF THE PHOTOGRAPHS

Photographs 1 and 2 show the bicycle at rest, with the READYLOCK (painted day-glow orange for easy identification), in it's resting or riding position. A manufactured READYLOCK would not need to be as wide as depicted.

Photographs 3 and 4 are simulating the removal of the locking crossbar, and the swinging forward of the lock arms to place the lock over the front wheel.

FIG. 5 shows just how simple and convenient the BICYCLE READYLOCK actually is. The crossbar has been relocked on the arms.

FIG. 6 shows the READYLOCK back up in the riding position, and also just how unobtrusive and out of the way the lock actually

FIG. 7 shows again the simplicity of locking the front wheel securely to disable the bike, as far as bike thiefs are concerned. Again, it is a simple unlocking of the crossbar to enable the lock to be swung back up to the riding position.

FIG. 8 shows just how little room the READYLOCK takes up on the frame. This frontal view shows the lock up, for riding, and as oversize as my mock-up model is, it did not interfere with my pedaling in any way. I rode five miles, and the lock never once rubbed against my legs, or interfered with pedaling in any way.

1: My invention is the BICYCLE READYLOCK, a new and revolutionary type of lock system that is lightweight, permanently mounted to the frame for immediate use, and does not need to be carried in a carrying bracket or coiled around some part of the frame or wrapped on the seatpost, all of which are cumbersome and time consuming.

2: The BICYCLE READYLOCK is never in the way of pedaling or in the way of other frame mounted accessories.

3: The BICYCLE READYLOCK can be retrofitted to older bicycles by simply having a competent bicycle shop drill and tap the mounting holes for the swivel bracket and U-lock set, or even more securely weld the swivel bracket to the most advantageous part of the frame.
